(19) United States
(12) Patent Application Publication
(10) Pub. No.: US 2010/0267359 A1
(43) Pub. Date: Oct. 21, 2010

(54) Mobile Phone Rapid Emergency Dispatch and Paging System and Method

(76) Inventor: Jonas L. Gyllensvaan, Potomac Falls, VA (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/763,967

(22) Filed: Apr. 20, 2010

Related U.S. Application Data
(60) Provisional application No. 61/170,899, filed on Apr. 20, 2009.

(51) Int. Cl. H04M 11/04

(52) U.S. Cl. 455/404.1

(57) ABSTRACT

Some embodiments of the invention provide a system including a first system client operating on a first handheld device. The first system client can include a client interface for a user to create a message and a prompt for the user to select one of a first broadcast method, a second broadcast method, and a third broadcast method for transmitting the message. The system can also include at least one first server capable of transmitting the message via the first broadcast method, a network operations center capable of transmitting the message via the second broadcast method, and a carrier network capable of transmitting the message via the third broadcast method.

### RELATED APPLICATIONS

This application claims priority under 35 U.S.C. §119 to U.S. Provisional Patent Application No. 61/170,899 filed on Apr. 20, 2009, the entire contents of which is incorporated herein by reference.

### BACKGROUND

In emergency situations, quick and effective communication can vastly improve operational effectiveness and safety. First responders and emergency communication teams cannot function effectively without the ability to quickly and easily share information and resources. In critical situations, fast response time and efficient coordination of emergency response can save lives.

### SUMMARY

Some embodiments of the invention provide a method for broadcasting messages using a dispatch system. The method may include receiving a message from a first user created on one of a first user computer and a first user handheld device, receiving a list including at least one second user to receive the message, and receiving a desired message type. The message type can be selected by the first user from a list including a first message option, a second message option, and an any available option. The method may also include determining a desired broadcast method based on the desired message type and retrieving contact information based on the desired broadcast method from an address book stored on one of the first user handheld device and a system database for each of the at least one second user. The method can further include transmitting the message to at least one second handheld device of the at least one second user using the contact information and the desired broadcast method and receiving a confirmation when the at least one second user acknowledges the message.

Some embodiments of the invention provide a system for a user. The system may include a first system client operating on a first handheld device. The first system client can include a client interface for the user to create a message and a prompt for the user to select one of a first broadcast method, a second broadcast method, and a third broadcast method for transmitting the message created on the client interface. The system may also include a second system client operating on a second handheld device, and at least one first server in communication with the first system client and the second system client and capable of transmitting the message to the second system client via the first broadcast method, a network operations center in communication with the first system client and the second system client and capable of transmitting the message to the second system client via the second broadcast method, and a carrier network in communication with the first system client and the second system client and capable of transmitting the message to the second system client via the third broadcast method.

Some embodiments of the invention provide a system for an organization including an administrator and a plurality of users. The system may include a plurality of handheld devices for each of the plurality of users. The plurality of handheld devices can each include a system client being operated by a processor of each of the handheld devices, and the system client is capable of transmitting a message created through a single message interface via at least two different broadcast methods. The system may also include a computer including a processor for operating a web interface and in communication with the plurality of handheld devices via a system network. The web interface can provide an on-demand location tool for the administrator which transmits a request for each of the plurality of handheld devices to transmit their global positioning system coordinates back to the web interface and displays the global positioning system coordinates for each of the plurality of handheld devices for the administrator to view. The web interface can also provide an administrative tool which allows the administrator to remotely access and control the system client of each of the plurality of handheld devices.

### DESCRIPTION OF THE DRAWINGS

FIG. 1 is a schematic view of a mobile phone rapid emergency dispatch and paging system according to one embodiment of the invention.

FIG. 2 is a screen view of a system client displaying message sending options in the dispatch system of FIG. 1.

FIG. 3 is a schematic view of a PIN messaging operation initiated by the dispatch system of FIG. 1.

FIG. 4 is a schematic view of a SMS messaging operation by the dispatch system of FIG. 1.

FIG. 5 is a schematic view of a PUSH messaging operation by the dispatch system of FIG. 1.

FIG. 6 is a schematic view of an “any available” messaging operation initiated by the dispatch system of FIG. 1.

FIG. 7 is a screen view of a system client displaying a sample message from the dispatch system of FIG. 1.

FIG. 8 is screen view of a system client on a handheld device displaying a sample message from the dispatch system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

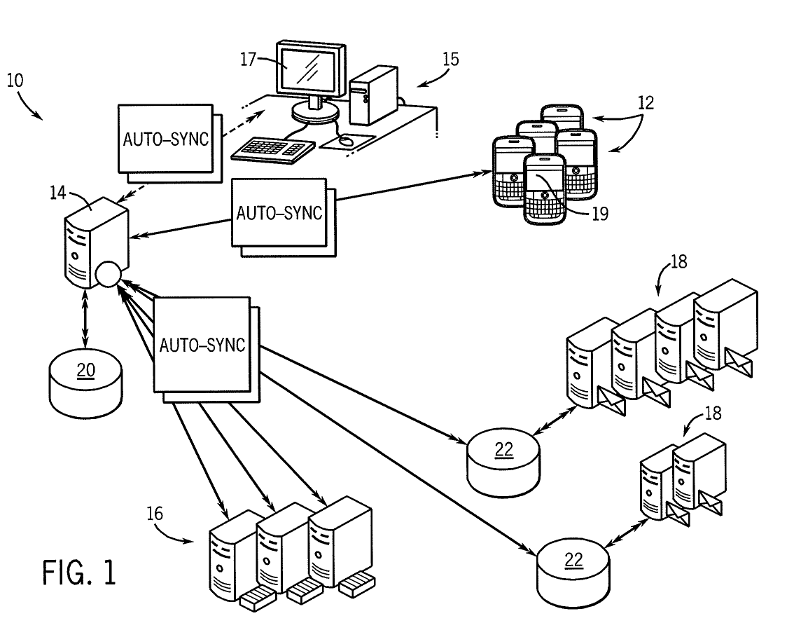

FIG. 1 illustrates a mobile phone rapid emergency dispatch and paging system 10 (hereinafter “the dispatch system”) according to one embodiment of the invention. The dispatch system 10 can be an all-in-one, single-point-of-control system that can be used with one or more handheld devices 12, such as a BlackBerry® or other smartphone (e.g., as a plug-in component), to allow features such as sending instant communications, initiating automatic conference calls, sending critical documents, and tracking communications.

In some embodiments, the dispatch system 10 can be used by a group, or organization, of users and can be controlled by an administrator. The administrator can first install a program associated with the dispatch system 10 on a web server such as an internet information server 14 using a desktop or personal computer 15. Once installed, the administrator can then use a dispatch system web interface 17, or web console, on the desktop or personal computer 15 (i.e., through program operations stored on the internet information server 14 and carried out by a processor of the computer 15). From the web interface 17, the administrator can configure the dispatch system 10 on each user's handheld device 12 (i.e., smartphone or Blackberry®). The administrator can also develop an active directory 16 to manage user information within the organization. The active directory 16 can include a plurality of fields (e.g., up to around 400) of information specific to each user and/or each user's handheld device 12.

As shown in FIG. 1, the dispatch system 10 can constantly or periodically synchronize any or all fields in the active directory 16 to each user's handheld device 12. Further, the dispatch system 10 can constantly or periodically coordinate and synchronize information within enterprise servers 18 (e.g., BlackBerry® enterprise servers) to the active directory 16, and to each user's handheld device 12. Data from the enterprise servers 18 can include lists of users currently on each enterprise server 18 and user details, such as phone number, personal identification number (PIN), and e-mail address.

The dispatch system 10 can include a dispatch system database 20 (which can be installed on a structured query language, or SQL, server) to store all information from one or more active directories 16, the enterprise servers 18, and each user's handheld device 12. For example, data can be imported from enterprise servers 18 and then stored in the dispatch system database 20 after an existing dataset is first deleted. The dispatch system 10 can use both push and pull technology to synchronize information between the active directories 16, the enterprise servers 18, the dispatch system database 20, and each user's handheld device 12. In some embodiments, all dispatch system database communications can be performed using Microsoft ADO (ActiveX Data Objects) and all dispatch system database inserts and updates can be performed with parameterized stored procedures for efficient performance. All active directory management can be accomplished using an Active DS Type Library. In addition, the dispatch system 10 can communicate with configured active directories 16 and enterprise servers 18 from different domains, allowing the administrator to send messages to users and groups from other organizations.

In order to use the dispatch system 10, each user or administrator can install a dispatch system client 19 on a handheld device 12. Once the dispatch system client 19 is installed, the dispatch system can operate in the background as a service on each handheld device 12 (e.g., as carried out by a processor of the handheld device 12). The user can then create, send, receive, and/or review messages via the dispatch system 10, depending on the user's security level (as further described below). Also, once the dispatch system client 19 is installed, the administrator can define templates, configuration options, security settings, etc. for the user via the web interface 17.

The web interface 17 can provide an administrative tool for the administrator and select users and also a messaging wizard for the administrator and all users. The administrative tool can act as a central command center to allow the administrator (or select users) to view and/or update dispatch system properties, system features, and e-mail configurations. The administrative tool can also allow the administrator (or select users) to define users, groups, message templates, and conferencing options for the dispatch system 10. A user management portion of the administrative tool can allow the administrator to add users who will have the rights to use the dispatch system 10 among the organization. Once the user has been added by the administrator and the dispatch system client 19 has been installed on their handheld device 12, they can be considered to be configured for the dispatch system 10. Also, the dispatch system can include multiple layers of security by encrypting all passwords and user information. In some embodiments, certain portions of the administrative tool can also be accessed by the administrator via a handheld device 12. In addition, each user can be given a unique username and password such that they may log into the dispatch system 10 on their handheld device 12 or sign into the dispatch system web interface 17 on a desktop or personal computer 15 to access the dispatch system 10.

In some embodiments, the administrative tool can enable the administrator to choose the levels of security for each user (e.g., the ability to read, approve, and/or create messages). For example, users who only have the ability to read can only receive alerts on their handheld device 12. Users who have the ability to read and approve can receive alerts and also approve them. The approval process can be for organizations that require an additional level of security within their deployment prior to alerts being sent to all users. Users who have the ability to read, approve, and create can receive alerts, compose such alerts on a web interface 17 or on their handheld device 12, and also engage in the approval process.

In addition, the administrator can modify login restrictions for each user. For example, certain users can only use the dispatch system 10 on certain days of the week (e.g., Monday through Friday). In another example, certain users can only log in to the dispatch system 10 from specific IP addresses. The administrator can also permit select users to have administrative capabilities (such as adding other users or modifying user security and restrictions, as described above). Also, users can be deleted via the user management portion of the administrative tool.

Once users are defined, the administrator can then use a group management portion of the administrative tool to define groups. Groups can define categories of users to which mass alerts can be sent. The group management portion can allow the administrator to search for users or scroll through a list of available (e.g., configured) users to add to a group. In addition, groups can be deleted via the group management portion. The above-described operations can be performed by separate software components of the dispatch system 10 developed, for example, in both Visual Basic and C++ and carried out by a processor on the administrator computer 15 and/or the internet information server 14.

Any updates to a user's settings or any new activations can be pushed to the user's handheld device at a pre-scheduled time. For example, the dispatch system 10 can have separate timers based on an interval read from a windows registry. At a specific timer interval, a timer can order a push of updates to all users. At a different specific timer interval, another timer can order a push of activities to be performed for new activations. Such timing techniques can also be used for data imports to and/or data correlation within the active directory 16 and the dispatch system database 20. For example, updated group information can reach users' handheld devices 12 via a push operation at a specified time interval.

To easily retrieve user and handheld device information, the dispatch system 10 can import data from configured enterprise servers 18. The dispatch system 10 can upload such data into the dispatch system database 20. The dispatch system 10 can then correlate users that have been configured as dispatch system users with the data extracted from corresponding enterprise server management databases 22. The dispatch system 10 can look up each user's properties (e.g., according to e-mail address) and query corresponding active directory information for active directory field values configured to be extracted and synchronized. The dispatch system 10 then can insert the field values into the dispatch system database 20. Any user's records and information already in the dispatch system database can be compared with the newly imported data and any changes can be updated into the user's record and time-stamped (e.g., with UNIX time). The above process can be configured to run at any time interval, such as every six, twelve, or twenty-four hours, to ensure that every record within the dispatch system 10 has current and up-to-date information from both the enterprise servers 18 and the active directory 16.

Further, on a configurable interval, each handheld device 12 can query the dispatch system database 20 for changes that have occurred since the last synchronization or check-in (i.e., pull for information). Any changes, additions, and/or deletions since the last synchronization can be downloaded by the handheld device 12. Each unique record on the handheld device 12 can be updated with the changes since the last synchronization, and additions and deletions will then processed. Every address entry from the dispatch system database 20 can be compared with the handheld device's personal information management (PIM) contacts or address book. If a match is found, that record can be updated with any active directory field values as configured. If no match is found, a new entry can be created in the handheld device's contacts or address book. The above process can ensure that every user has a fully synchronized and up-to-date entry for each user in the organization, including essential information such as phone, e-mail and personal identification number (PIN) information as well as all configured values from the active directory 16. Also, having each handheld device 12 pull down any changes can provide a natural workload distribution and prohibit server congestion.

The administrative tool can also include a message templates portion to allow the administrator (or select users) to create, modify, and/or remove message templates. A name of the template, a subject that would show up when the message is sent, and the message itself can all be created or modified via the message templates portion. Message templates can make it easier for the administrator or select users to send alerts to groups or other users quickly and efficiently.

To send a message, a user (i.e., a user with the capability to create messages) can select to create a message on the handheld device 12 or the web interface 17. The user can then select a message sending option and a message level. The user can then optionally select a message template and links to add to the message, such as links to web pages, phone numbers for conference calling, photos, or documents. In some embodiments, links can include images and documents for Continuity of Operations Plans (COOP) or emergency procedures. The user can then create a message or modify the message template, select the users or group the message should be sent to, and send the message. In some embodiments, the above steps can occur in any order. For example, the user can create a message and later add links to web pages.

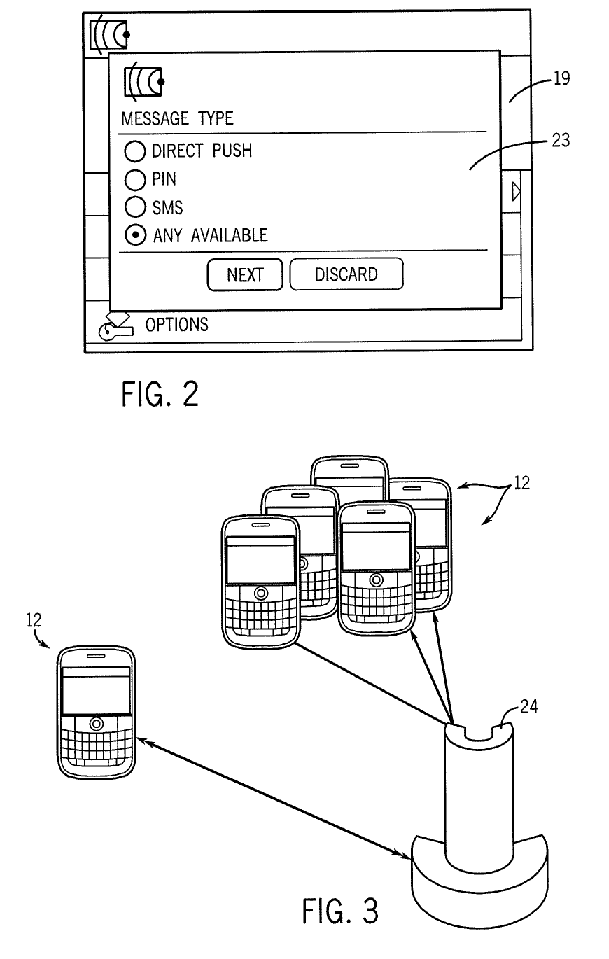

Messages can be created via a messaging interface 23 of the dispatch system client 19 or the web interface 17. In some embodiments, the dispatch system 10 can include four different kinds of message sending options, or message types, which a user can select from in order to transmit the message created on the messaging interface. The four message types can include PUSH Message, Personal Identification Number (PIN) Message, SMS message, and “any available” message, as shown in FIG. 2. The single messaging interface 23 is capable of creating messages which can be transmitted via different broadcasting methods, depending on the message type selected.

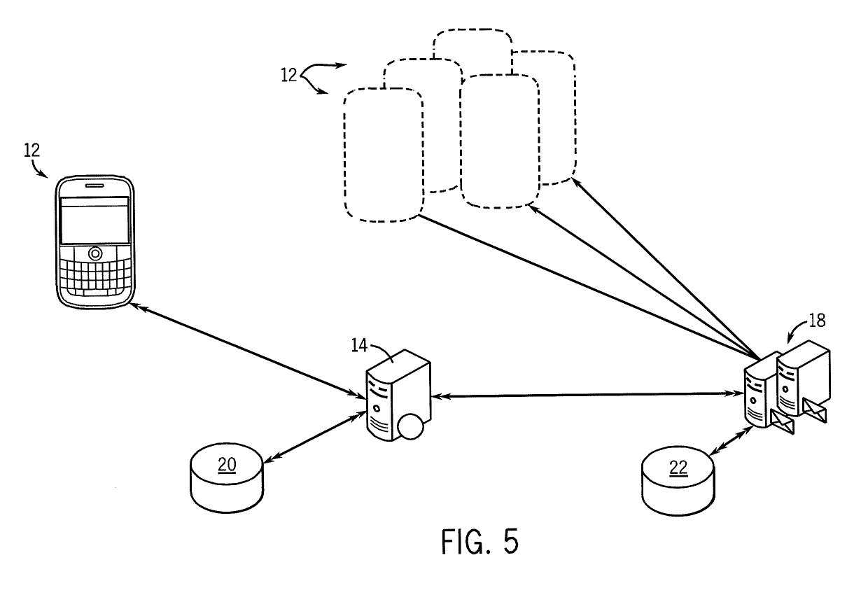

When the PUSH message type is selected, a message can be sent via a PUSH broadcast method. For example, when the PUSH message type is selected, the dispatch system 10 can determine that the PUSH broadcast method will be used and a list of the recipients and groups can be pushed to the internet information server 14. The internet information server 14 can then look up each recipient user's enterprise server 18 (e.g., within the dispatch system database 20), and then a push, such as a mobile data system (MDS) push, can be initiated to each recipient user's handheld device 12 through each recipient user's corresponding enterprise server 18 using, for example, HTTP (hypertext transfer protocol) or HTTPS (secure HTTP) connectivity, as shown in FIG. 5. PUSH messaging can be sent from a BlackBerry® handheld device 12 or the dispatch system web interface 17 to another BlackBerry® handheld device 12 or any other smartphone-type handheld device 12.

When the PIN message type is selected, a message can be sent via a PIN messaging broadcast method. For example, when the PIN message type is selected, the dispatch system 10 can determine that the PIN messaging broadcast method will be used and each recipient handheld device's personal identification number (e.g., BlackBerry® PIN) can be retrieved from a dispatch system address book on the sender's handheld device 12. A BlackBerry® PIN is an eight character hexadecimal identification number assigned to each BlackBerry® handheld device 12. Personal identification numbers cannot be changed and are locked to each handheld device 12. Once retrieved, the personal identification numbers can be created and queued on the sender's handheld device 12 and sent through a RIM (research in motion) network operations center (NOC) 24 to each recipient user, as shown in FIG. 3. PIN messaging may only be used when messages are from a BlackBerry® handheld device 12 to another one or more BlackBerry® handheld devices 12, as only these types of handheld devices 12 carry the appropriate personal identification numbers for such messaging. PIN messaging can be quicker than conventional e-mail and appear on a recipient user's handheld device 12 as a conventional text message, therefore not filling up the user's e-mail inbox. In some embodiments, other handheld devices 12 can be capable of PIN messaging as long as the sending and receiving handheld devices 12 have a similar personal identification numbering scheme.

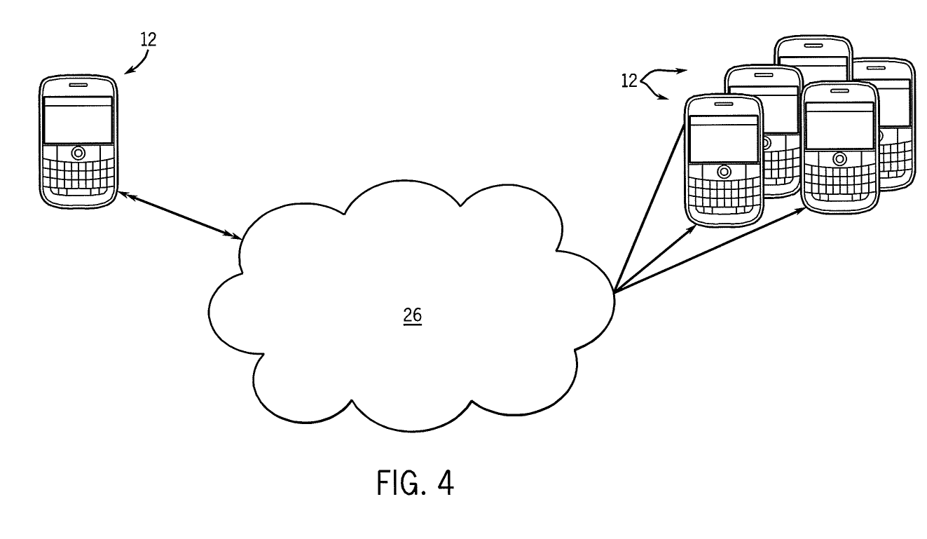

When the SMS message type is selected, a message can be sent via an SMS broadcast method. For example, when the SMS message type is selected, the dispatch system 10 can determine that the SMS broadcast method will be used and each recipient user's phone number can be retrieved from the dispatch system address book on the sender's handheld device 12, and then created and queued on the sender's handheld device 12 and sent directly through a carrier network 26, as shown in FIG. 4. SMS (short message service) messaging can be conventional text messages sent from a BlackBerry® handheld device 12 to another BlackBerry® handheld device 12 or any other smartphone-type handheld device 12 (e.g., iPhone or Windows mobile phone).

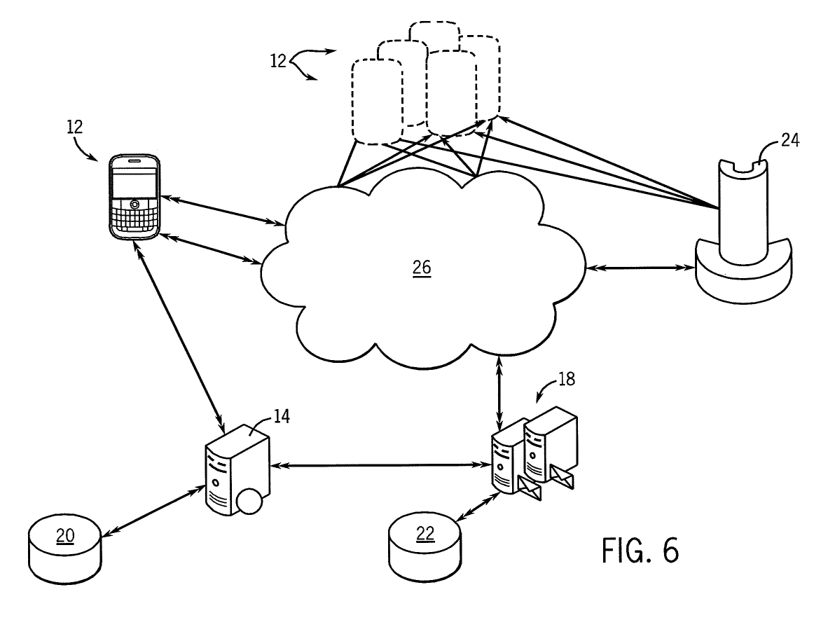

When the “any available” message type is selected, the dispatch system 10 can follow a message delivery priority ladder to provide the quickest option to send the message: first the PUSH message broadcast method, then the PIN message broadcast method, then SMS broadcast method. As shown in FIG. 6, the dispatch system 10 can first verify which message broadcast methods are available and working correctly. For example, first, a PUSH message is initiated and sent directly to the same handheld device 12 that is trying to broadcast the message (i.e., the sender's handheld device 12). This can verify if the PUSH broadcast method is working. If this fails, the message can be sent again to the sender's handheld device 12 using the PIN messaging broadcast method. If neither of these methods are successful, the handheld device 12 can directly send the message via the SMS broadcast method.

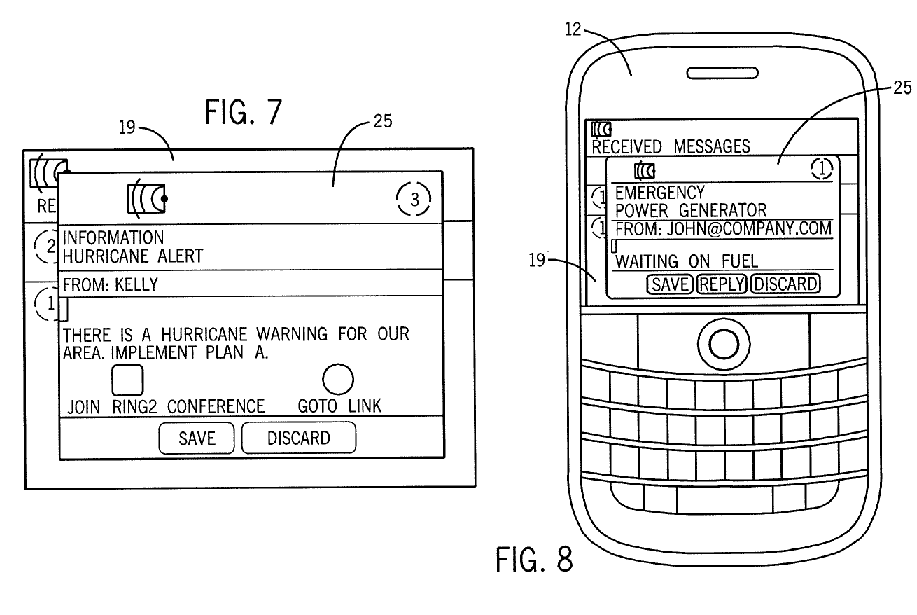

When sending a message, the user can select a message level from, for example, one of the following options: level 1 (e.g., emergency), level 2 (e.g., warning), and level 3 (e.g., information). Once a dispatch system message is received on a handheld device 12, regardless of the broadcast method and message level, a persistent message box 25 including the message is displayed, as shown in FIGS. 7 and 8. The message levels can then correspond to what other actions the recipient user's handheld device 12 performs when the message is received.

For example, if a level 1 message is sent (as shown in FIG. 8), the message box can override any and all other applications regardless of the currently selected profile on the handheld device 12. The message box 25 can remain in the foreground of the handheld device 12 and cannot be closed until the message is acknowledged. During this time the handheld device 12 can vibrate and sound an audible alert (e.g., every two minutes) until the message is acknowledged, regardless of the whether the handheld device 12 is on a “silent” or “vibrate only” profile. If a level 2 message is sent, the handheld device 12 can vibrate (e.g., every two minutes) and the message box 25 can remain in the foreground of the handheld device 12 and cannot be closed until the message is acknowledged, regardless of the whether the handheld device 12 is on a “silent” profile. If a level 3 message is sent (as shown in FIG. 7), the message box 25 can remain in the foreground of the handheld device and cannot be closed until the message is acknowledged (without any sound or vibration).

Regardless of the message level, no other function or applications of the handheld device 12 can be used until the message is acknowledged (i.e., the handheld device 12 can be rendered useless until the message is acknowledged). In some embodiments, a message can be considered acknowledged by a user if the user selects one of the following: a conference call link within the message, a web page link within the message, an attachment within the message, a save option, a reply option, or a discard option (as shown in FIGS. 7 and 8).

Level 1 messages can be sent in critical situations (e.g., severe weather conditions, wildfire, earthquakes, terrorist situations, missing children, etc). An example display of a level 1 message on a user's handheld device 12, labeled as “emergency” with a circled “1” in the right-hand corner, is shown in FIG. 8. Level 3 messages can be simple day-to-day messages for business activities (e.g., field service issues, product or production facility problems, business continuity changes, etc.). An example display of a level 3 message on a user's handheld device 12, labeled as “information” with a circled “3” in the right-hand corner, is shown in FIG. 7. In addition to the text shown in FIG. 7, the message includes a link to automatically join a conference call and a link to view a web page.

When a recipient receives and/or acknowledges the message, the sender can automatically receive a confirmation message with a date and time stamp of when the message was acknowledged, and/or a location of the recipient's handheld device 12 (e.g., via global positioning system, or GPS, technology). In addition, when a recipient user receives a message, the user can immediately join a conference call or view any linked or attached web pages, images, or documents. For example, the message can include a “join conference call” icon (as shown in FIG. 7). By selecting the icon, the user can either be provided with a number to call (and call the number by selecting the “send” button on their handheld device 12) or be automatically routed to a conference call. The conference call function can allow a group of users to quickly get in contact, which may be very important when an emergency operation must be discussed or explained among the group or organization. This can be much more simple than conventional conference calls where the user first receives a number and entrance code, for example, via e-mail. The user must then manually dial the number and then enter the entrance code, which usually must be memorized as the e-mail message is replaced by the call screen when the user calls the number.

Message activity via the dispatch system 10 can be fully traceable (e.g., for auditing purposes). For example, the date and time when the message was created, the date, time, and location of the recipient's handheld device 12 when the message was received, and the date, time, location, and actions completed once the message was acknowledged can all be stored in the dispatch system database for retrieval. Even if a handheld device 12 is out of range for communication with the active directory, the handheld device 12 can locally store such information and later push the information to the active directory 16. In addition, if a handheld device 12 is out of range for communication for a substantial amount of time, the handheld device 12 can also pull information from the active directory 16 or enterprise server 18 when the handheld device 12 becomes available for communication to ensure proper synchronization of information and documents between the enterprise server database 22, the dispatch system database 20 and the handheld device 12.

In some embodiments, the dispatch system 10 can also provide reports that the administrator can pull to monitor messaging and other various activities within the organization via the web interface 17. Such information can be used for auditing purposes to see how effective communication played a role in, for example, the organization's response teams' ability to react to emergency situations. Example reports can include a quick log report, a message details report, a message log report, a contact information report, a dispatch system reports report, a user logon activity report, and a users report.

A quick log report can show a list of the dispatch system alerts based on criteria specified by the administrator. Example criteria can include message level, message type, sender, and date range. The quick log report can provide a log-type view of all the alerts that have been sent which fall under the specified criteria. The administrator can further select a specific alert in the report to view more information specifically related to the alert. For example, the administrator can view the sender, the subject, the message level, the message type, when the message was sent, the message itself, any links associated with the message, and/or the recipients of the message. In addition, the administrator can view further details about each recipient when they received the message (e.g., received time, acknowledged time, and location).

A message log report can be a summary display of all the dispatch system alerts that have been sent. The administrator can also use criteria (e.g., message level, message type, sender, and/or date range) to display a custom message log report. In one example, the message log report can display how many messages were sent within a specific week, as specified by the administrator. The administrator can further view the number of messages sent by day of that week and view information about each message sent on a specific day.

A message details report can allow the administrator to select a message and view tracking information about the message as well as detailed delivery statistics for each recipient. For example, the recipient's personal identification number, phone number, location, and any other identification numbers and information can be displayed. Also, the sent time, delivered time, and confirmed time can be displayed.

A contact information report and a dispatch system report can be helpful resources for the administrator. The contact information report can provide a quick list of important phone numbers and e-mail addresses of providers, sales teams, technical support teams, press contacts, etc. for the administrator. The dispatch system report can provide a listing of all current reports available to the administrator with associated descriptions for each report.

A user logon activity report can be used as an audit trail of user activity for the organization. Precise times that IP addresses and/or URLs (uniform resource locators) were accessed by a user on a specific date can be displayed. The users report can provide a listing of all user accounts on the dispatch system. The users report can detail last logon time, number of logins, and account descriptions for each user.

In addition to viewing reports specific to users and sending messages to users, the administrator can also remotely monitor the user in real-time or near real-time and control applications and viewable information on the user's handheld device 12 via the web interface 17. In one example, the administrator, via the web interface 17, can remotely request a “dump” (i.e., a deleting) of all, or specific, messages, calls, and/or applications on any user's handheld device 12.

In another example, the web interface 17 can include an on-demand location tool to determine the location of a specific user. The on-demand location tool can allow the administrator to, at any given time, request the location of a specific user's handheld device 12 via the dispatch system 10. The dispatch system 10 can use GPS technology to determine the handheld device's location, with or without any notification to the user that this request has occurred, and return the location (e.g., the GPS coordinates) to the administrator. Specifically, a command can be sent from the web interface 17 to the dispatch system client 19 on the user's handheld device 12 via, for example, a wireless network or the carrier network 26. Once the command is received, the dispatch system client 19 can boot an internal GPS engine on the handheld device 12 so that real-time GPS coordinates can be acquired and submitted back to the web interface 17. Once received, the web interface 17 can plot the GPS coordinates onto a public web-based mapping facility for a clear context of the user's location. The on-demand tool can also be used for multiple users in that the command can be sent to an entire group to retrieve locations of all users in the group and their proximity to each other. The administrator can also request that the handheld device 12 report, or push, its location at scheduled time intervals without the user knowing.

The various tools and operations carried out by the dispatch system 10, as described above, can be stored as computer-readable instructions or data on a computer readable medium of the dispatch system database 20, the user computer 15, the handheld device 12, or other databases, computers, or devices in communication with the internet information server 14. For the purposes of this disclosure a computer readable medium stores computer data, which data can include computer program code that is executable by a computer or processor, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method for broadcasting messages using a dispatch system, the method comprising:
receiving a message from a first user created on one of a first user computer and a first user handheld device;
receiving a list including at least one second user to receive the message;
receiving a desired message type, the message type selected by the first user from a list including a first message option, a second message option, and an any available option;
determining a desired broadcast method based on the desired message type;
retrieving contact information based on the desired broadcast method from an address book stored on one of the first user handheld device and a system database for each of the at least one second user;
transmitting the message to at least one second handheld device of the at least one second user using the contact information and the desired broadcast method; and
receiving a confirmation when the at least one second user acknowledges the message.

2. The method of claim 1, wherein the first message option correlates to a first broadcast method, the second message option correlates to a second broadcast method, and the any available option correlates to the first broadcast method when the first broadcast method is available and working correctly and the second broadcast method when the first broadcast method is one of not available and not working correctly.

3. The method of claim 1, wherein the message includes at least one of text, a web link, an attached document, an attached image, and a conference call link.

4. The method of claim 1, wherein the message includes a conference call link, and further comprising automatically initiating the at least one second user handheld into a conference call when the at least one second user selects the conference call link.

5. The method of claim 1, wherein the confirmation includes at least one of a date and a time when the message was acknowledged and a global positioning system location of the at least one second handheld device when the message was acknowledged.

6. The method of claim 1 and further comprising receiving a message alert level from the first user; and alerting the at least one second user of the message on the at least one second user handheld device based on the message alert level, wherein alerting the at least one second user includes one of displaying the message on the at least one second user handheld device and rendering all other functions of the at least one second handheld device useless until the message is acknowledged, causing the at least one second user handheld device to vibrate, and causing the at least one second user handheld device to play an auditory alert.

7. The method of claim 1 and further comprising transmitting the message to a third user and transmitting the message to the at least one second handheld device only after receiving approval from the third user.

8. The method of claim 1 and further comprising providing a message template to the first user on one of the first user computer and the first user handheld device.

9. The method of claim 1, wherein the desired message type is selected from a list including the first message option, the second message option, the any available option, and a third message option, wherein the third message option correlates to a third broadcast method.

10. The method of claim 1, wherein the first message option is a PUSH message and the second message option is a PIN message.

11. The method of claim 1 and further comprising storing the message, a date and a time for when the message was created, and the confirmation in the server database.

12. A system for a user, the system comprising:
a first system client operating on a first handheld device, the first system client including a client interface for the user to create a message and a prompt for the user to select one of a first broadcast method, a second broadcast method, and a third broadcast method for transmitting the message created on the client interface;
a second system client operating on a second handheld device;
at least one first server in communication with the first system client and the second system client and capable of transmitting the message to the second system client via the first broadcast method;
a network operations center in communication with the first system client and the second system client and capable of transmitting the message to the second system client via the second broadcast method; and
a carrier network in communication with the first system client and the second system client and capable of transmitting the message to the second system client via the third broadcast method.

13. The system of claim 12 and further comprising a database including contact information of the first handheld device and the second handheld device and general information about users and settings of the first system client and the second system client.

14. The system of claim 13, wherein the contact information and the general information are synchronized between the database and the first system client and the second system client using push technology and pull technology.

15. The system of claim 12 and further comprising a system web interface operating on a computer and in communication with the first system client and the second system client, the system web interface including a messaging interface for the user to create the message and a message prompt for the user to select one of the first broadcast method, the second broadcast method, and the third broadcast method for transmitting the message created on the message interface.

16. The system of claim 15, wherein the system web interface includes an administrative tool for the user to view and modify at least one of security settings, login restrictions, group listings, and synchronization times.

17. The system of claim 15, wherein the system web interface includes an administrative tool for the user to view reports including messaging activity between the first system client and the second system client.

18. The system of claim 15, wherein the system web interface includes a location tool for the user to retrieve global positioning system coordinates of one of the first handheld device and the second handheld device.

19. A system for an organization including an administrator and a plurality of users, the system comprising:
a plurality of handheld devices for each of the plurality of users, the plurality of handheld devices each including a system client being operated by a processor of each of the handheld devices, the system client capable of transmitting a message created through a single message interface via at least two different broadcast methods; and
a computer including a processor for operating a web interface and in communication with the plurality of handheld devices via a system network,
the web interface providing an on-demand location tool for the administrator which transmits a request for each of the plurality of handheld devices to transmit their global positioning system coordinates back to the web interface and displays the global positioning system coordinates for each of the plurality of handheld devices for the administrator to view,
the web interface providing an administrative tool which allows the administrator to remotely access and control the system client of each of the plurality of handheld devices.

20. The system of claim 19, wherein the on-demand location tool causes the system client to display an alert on each of the plurality of handheld devices when they transmit their global positioning system coordinates back to the web interface.
